(19) United States
(12) Patent Application Publication
(10) Pub. No.: US 2026/0142594 A1
(43) Pub. Date: May 21, 2026

(54) MOTOR CONTROLLER

(71) Applicant: Global Mixed-mode Technology Inc., Hsin-Chu (TW)

(72) Inventor: Rong-Chin Lee, Pingtung County (TW)

(73) Assignee: Global Mixed-mode Technology Inc., Hsin-Chu (TW)

(21) Appl. No.: 18/950,202

(22) Filed: Nov. 18, 2024

(51) Int. Cl. H02P 6/17

(52) U.S. Cl. CPC H02P 6/17

(57) ABSTRACT

A motor controller is used for driving a motor. The motor controller comprises a switch circuit, a control circuit, and a Hall sensor. The Hall sensor is configured to generate a Hall signal to the control circuit. The control circuit is configured to generate a modulated Hall signal to the switch circuit. The modulated Hall signal is generated by an average calculation of the Hall signal and a positive-edge synchronization or a negative-edge synchronization of the Hall signal. The motor controller is configured to reduce noise.

### BACKGROUND OF THE INVENTION

### 1. Field of the Invention

The present invention relates to a motor controller, and more particularly, to a motor controller which is capable of reducing noise.

### 2. Description of the Prior Art

Generally speaking, it is a goal to reduce motor noise. The rotor of the motor may be divided into a plurality of pole regions. The motor controller may detect the plurality of pole regions for switching phases, so as to drive the motor. However, when the sizes of the plurality of pole regions differ due to a manufacturing tolerance, the prior-art method may generate motor noise.

Thus, a new motor driving technology is needed to reduce motor noise.

### SUMMARY OF THE INVENTION

According to the present invention, a motor controller which is capable of reducing noise is provided. The motor controller is used for driving a motor, where the motor has a motor coil and a rotor. The rotor comprises a first pole region, a second pole region, a third pole region, and a fourth pole region to switch phases. The motor controller comprises a switch circuit, a control circuit, and a Hall sensor. The switch circuit is configured to supply a motor current to the motor coil. The Hall sensor is configured to generate a Hall signal to the control unit. The control circuit is configured to generate a modulated Hall signal to the switch circuit. In addition, the control circuit further generates a rotational speed detection signal, where the rotational speed detection signal is coupled to a rotational speed signal pin.

The Hall signal generates a first time interval T01, a second time interval T02, a third time interval T03, a fourth time interval T04, a fifth time interval T05, a sixth time interval T06, a seventh time interval T07, and an eighth time interval T08. The modulated Hall signal has a first phase switching time, a second phase switching time, a third phase switching time, and a fourth phase switching time.

The modulated Hall signal is generated by an average calculation of the Hall signal and a positive-edge synchronization of the Hall signal. The first phase switching time may be equal to (T01+T02+T03+T04)/4. The second phase switching time may be generated by the positive-edge synchronization. When driving the motor via the modulated Hall signal, it is capable of reducing noise according to the present invention by experiment. The control circuit may generate the modulated Hall signal by a judging criteria. When the fifth time interval T05 is greater than or equal to (T01+T02+T03+T04)/4, the first phase switching time is equal to (T01+T02+T03+T04)/4. When the fifth time interval T05 is less than (T01+T02+T03+T04)/4, the first phase switching time may be generated by a positive-edge synchronization of the Hall signal or a negative-edge synchronization of the Hall signal. Besides, the rotational speed detection signal may be synchronized to the modulated Hall signal.

The modulated Hall signal is generated by an average calculation of the Hall signal and a negative-edge synchronization of the Hall signal. The first phase switching time may be generated by the negative-edge synchronization. The second phase switching time may be equal to (T02+T03+T04+T05)/4. When driving the motor via the modulated Hall signal, it is capable of reducing noise according to the present invention by experiment. The control circuit may generate the modulated Hall signal by a judging criteria. When the fifth time interval T05 is greater than or equal to (T01+T02+T03+T04)/4, the first phase switching time is equal to (T01+T02+T03+T04)/4. When the fifth time interval T05 is less than (T01+T02+T03+T04)/4, the first phase switching time may be generated by a positive-edge synchronization of the Hall signal or a negative-edge synchronization of the Hall signal. Besides, the rotational speed detection signal may be synchronized to the modulated Hall signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and accompanying drawings, wherein:

FIG. 1 is a schematic diagram showing a motor controller according to one embodiment of the present invention;

FIG. 2 is a schematic diagram showing a rotor according to one embodiment of the present invention;

FIG. 3 is a first timing chart according to one embodiment of the present invention; and

FIG. 4 is a second timing chart according to one embodiment of the present invention.

### DETAILED DESCRIPTION

Preferred embodiments according to the present invention will be described in detail with reference to the drawings.

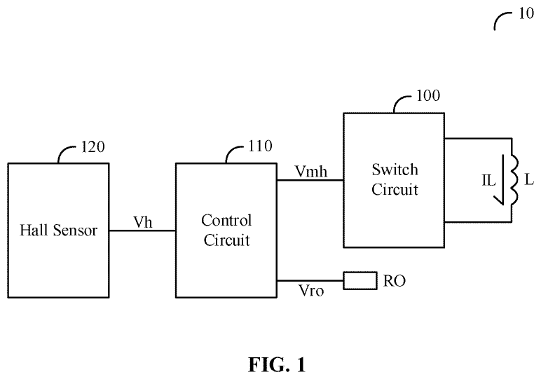

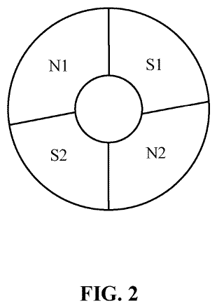

FIG. 1 is a schematic diagram showing a motor controller 10 according to one embodiment of the present invention. The motor controller 10 is used for driving a motor, where the motor has a motor coil L and a rotor. FIG. 2 is a schematic diagram showing the rotor according to one embodiment of the present invention. The rotor comprises a first pole region N1, a second pole region S1, a third pole region N2, and a fourth pole region S2 to switch phases. In an ideal case, each of the size of the first pole region N1, the size of the second pole region S1, the size of third pole region N2, and the size of the fourth pole region S2 should be equal to a quarter of the rotor. As shown in FIG. 2, practically each of the size of the first pole region N1, the size of the second pole region S1, the size of third pole region N2, and the size of the fourth pole region S2 is not equal to a quarter of the rotor due to a manufacturing error.

The motor controller 10 comprises a switch circuit 100, a control circuit 110, and a Hall sensor 120, where the switch circuit 100 may be a full-bridge circuit. The switch circuit 100 is configured to supply a motor current IL to the motor coil L. The control circuit 110 receives a Hall signal Vh for generating a modulated Hall signal Vmh to the switch circuit 100. The modulated Hall signal Vmh may be used for controlling the ON/OFF states of the switch circuit 100 so as to drive the motor. The Hall sensor 120 generates the Hall signal Vh to the control circuit 110 for switching phases. The Hall sensor 120 may be configured to detect the position change of the first pole region N1, the second pole region S1, the third pole region N2, and the fourth pole region S2 in the rotor, so as to generate the Hall signal Vh. Thus, the current pole region of the rotor can be obtained by the Hall signal Vh. Moreover, the control circuit 110 may further generate a rotational speed detection signal Vro for providing the user with rotational speed information, where the rotational speed detection signal Vro may be coupled to a rotational speed signal pin RO.

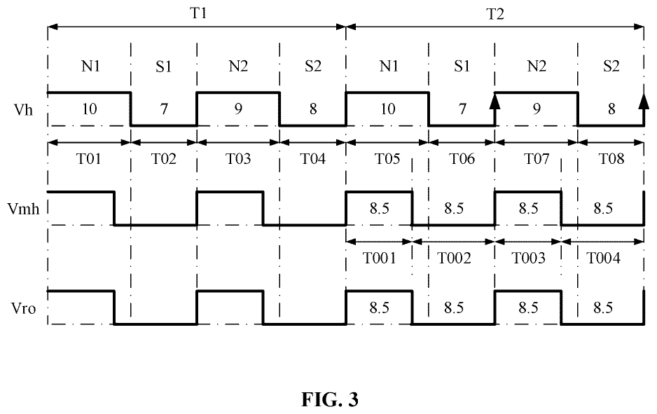

FIG. 3 is a first timing chart according to one embodiment of the present invention. The Hall signal Vh generates a first time interval T01, a second time interval T02, a third time interval T03, a fourth time interval T04, a fifth time interval T05, a sixth time interval T06, a seventh time interval T07, and an eighth time interval T08. The first time interval T01 corresponds to a first phase and the first pole region N1. The second time interval T02 corresponds to a second phase and the second pole region S1. The third time interval T03 corresponds to a third phase and the third pole region N2. The fourth time interval T04 corresponds to a fourth phase and the fourth pole region S2. The fifth time interval T05 corresponds to a fifth phase and the first pole region N1. The sixth time interval T06 corresponds to a sixth phase and the second pole region S1. The seventh time interval T07 corresponds to a seventh phase and the third pole region N2. The eighth time interval T08 corresponds to a eighth phase and the fourth pole region S2. The motor controller 10 enables the rotor to rotate 360 degrees for completing a first cycle during a first period T1 by the Hall signal Vh, where the first period T1 is equal to (T01+T02+T03+T04). Then the motor controller 10 enables the rotor to rotate 360 degrees for completing a second cycle during a second period T2 by the Hall signal Vh, where the second period T2 is equal to (T05+T06+T07+T08). The control circuit 110 may save the first time interval T01, the second time interval T02, the third time interval T03, and the fourth time interval T04 for driving the motor to complete the second cycle. The control circuit 110 may save the fifth time interval T05, the sixth time interval T06, the seventh time interval T07, and the eighth time interval T08 for driving the motor to complete a third cycle.

As shown in FIG. 3, the first time interval T01 may have 10 time units, the second time interval T02 may have 7 time units, the third time interval T03 may have 9 time units, the fourth time interval T04 may have 8 time units, the fifth time interval T05 may have 10 time units, the sixth time interval T06 may have 7 time units, the seventh time interval T07 may have 9 time units, and the eighth time interval T08 may have 8 time units, where the first pole region N1 may be greater than the second pole region S1 and the third pole region N2 may be greater than the fourth pole region S2. During the second cycle, the modulated Hall signal Vmh may have a first phase switching time T001, a second phase switching time T002, a third phase switching time T003, and a fourth phase switching time T004. The modulated Hall signal Vmh may be generated by an average calculation of the Hall signal Vh and a positive-edge synchronization of the Hall signal Vh, where the average calculation may be a two-pole average, a three-pole average, or a four-pole average. Take the four-pole average for example, the first phase switching time T001 may be equal to (T01+T02+T03+T04)/4 (i.e., 8.5 time units), the second phase switching time T002 may be generated by the positive-edge synchronization, the third phase switching time T003 may be equal to (T03+T04+T05+T06)/4 (i.e., 8.5 time units), and the fourth phase switching time T004 may be generated by another positive-edge synchronization. When driving the motor via the modulated Hall signal Vmh, it is capable of reducing noise according to the present invention by experiment. More specifically, the control circuit 110 may generate the modulated Hall signal Vmh by a judging criteria. For instance, when the fifth time interval T05 is greater than or equal to (T01+T02+T03+T04)/4, the first phase switching time T001 is equal to (T01+T02+T03+T04)/4. When the fifth time interval T05 is less than (T01+T02+T03+T04)/4, the first phase switching time T001 may be generated by a positive-edge synchronization of the Hall signal or a negative-edge synchronization of the Hall signal. In addition, the two-pole average and the three-pole average may be obtained through the analogy of the above embodiment and thus the detailed implementation is omitted here. The rotational speed detection signal Vro may be synchronized to the modulated Hall signal Vmh for the user to detect the rotational speed.

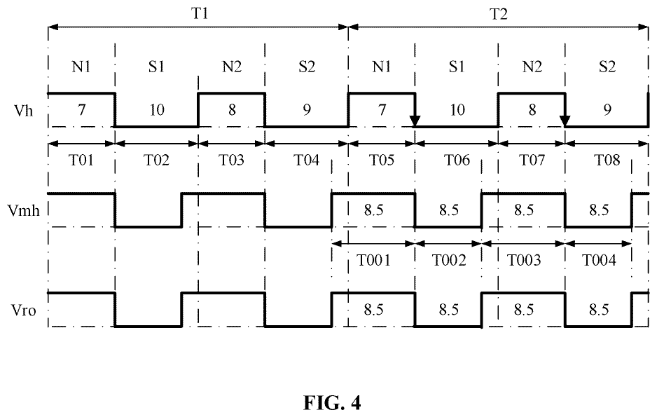

FIG. 4 is a second timing chart according to one embodiment of the present invention, where the main difference between FIG. 3 and FIG. 4 is resulted from the size of the individual pole region. As shown in FIG. 4, the first time interval T01 may have 7 time units, the second time interval T02 may have 10 time units, the third time interval T03 may have 8 time units, the fourth time interval T04 may have 9 time units, the fifth time interval T05 may have 7 time units, the sixth time interval T06 may have 10 time units, the seventh time interval T07 may have 8 time units, and the eighth time interval T08 may have 9 time units, where the first pole region N1 may be less than the second pole region S1 and the third pole region N2 may be less than the fourth pole region S2. During the second cycle, the modulated Hall signal Vmh may have the first phase switching time T001, the second phase switching time T002, the third phase switching time T003, and the fourth phase switching time T004. Similarly, the modulated Hall signal Vmh may be generated by an average calculation of the Hall signal Vh and a negative-edge synchronization of the Hall signal Vh, where the average calculation may be a two-pole average, a three-pole average, or a four-pole average. Take the four-pole average for example, the first phase switching time T001 may be generated by the negative-edge synchronization, the second phase switching time T002 may be equal to (T02+T03+T04+T05)/4 (i.e., 8.5 time units), the third phase switching time T003 may be generated by another negative-edge synchronization of the Hall signal Vh, and the fourth phase switching time T004 may be equal to (T04+T05+T06+T07)/4 (i.e., 8.5 time units). When driving the motor via the modulated Hall signal Vmh, it is capable of reducing noise according to the present invention by experiment. More specifically, the control circuit 110 may generate the modulated Hall signal Vmh by a judging criteria. For instance, when the fifth time interval T05 is greater than or equal to (T01+T02+T03+T04)/4, the first phase switching time T001 is equal to (T01+T02+T03+T04)/4. When the fifth time interval T05 is less than (T01+T02+T03+T04)/4, the first phase switching time T001 may be generated by a positive-edge synchronization of a Hall signal or a negative-edge synchronization of a Hall signal. In addition, the two-pole average and the three-pole average may be obtained through the analogy of the above embodiment and thus the detailed implementation is omitted here. The rotational speed detection signal Vro may be synchronized to the modulated Hall signal Vmh for the user to detect the rotational speed.

According to one embodiment of the present invention, the motor controller 10 may be applied to a cooling fan. The cooling fan may be applied to an artificial intelligence computer, such that it is capable of reducing noise under a multiple-fan configuration.

While the present invention has been described by the preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor controller configured to drive a motor, wherein the motor has a motor coil, and the motor controller comprising:
a switch circuit, configured to supply a motor current to the motor coil;
a control circuit; and
a Hall sensor, configured to generate a Hall signal to the control unit, wherein the control circuit is configured to generate a modulated Hall signal to the switch circuit, and the modulated Hall signal is generated by an average calculation of the Hall signal and a positive-edge synchronization of the Hall signal.

2. The motor controller of claim 1, wherein the average calculation is a two-pole average or a three-pole average.

3. The motor controller of claim 1, wherein the average calculation is a four-pole average.

4. The motor controller of claim 1, wherein the Hall signal generates a first time interval T01, a second time interval T02, a third time interval T03, and a fourth time interval T04, the modulated Hall signal has a first phase switching time and a second phase switching time, the first phase switching time is equal to (T01+T02+T03+T04)/4, and the second phase switching time is generated by the positive-edge synchronization.

5. The motor controller of claim 1, wherein the control circuit generates the modulated Hall signal by a judging criteria.

6. The motor controller of claim 1, wherein the Hall signal generates a first time interval T01, a second time interval T02, a third time interval T03, a fourth time interval T04, and a fifth time interval T05, the modulated Hall signal has a first phase switching time, and when the fifth time interval T05 is greater than or equal to (T01+T02+T03+T04)/4, the first phase switching time is equal to (T01+T02+T03+T04)/4.

7. The motor controller of claim 1, wherein the Hall signal generates a first time interval T01, a second time interval T02, a third time interval T03, a fourth time interval T04, and a fifth time interval T05, the modulated Hall signal has a first phase switching time, and when the fifth time interval T05 is less than (T01+T02+T03+T04)/4, the first phase switching time is generated by the positive-edge synchronization or a negative-edge synchronization of the Hall signal.

8. The motor controller of claim 1, wherein the control circuit further generates a rotational speed detection signal, and the rotational speed detection signal is synchronized to the modulated Hall signal.

9. The motor controller of claim 8, wherein the rotational speed detection signal is coupled to a rotational speed signal pin.

10. The motor controller of claim 1, wherein the motor controller is applied to a cooling fan.

11. The motor controller of claim 10, wherein the cooling fan is applied to an artificial intelligence computer.

12. A motor controller configured to drive a motor, wherein the motor has a motor coil, and the motor controller comprising:
a switch circuit, configured to supply a motor current to the motor coil;
a control circuit; and
a Hall sensor, configured to generate a Hall signal to the control unit, wherein the control circuit is configured to generate a modulated Hall signal to the switch circuit, and the modulated Hall signal is generated by an average calculation of the Hall signal and a negative-edge synchronization of the Hall signal.

13. The motor controller of claim 12, wherein the average calculation is a two-pole average or a three-pole average.

14. The motor controller of claim 12, wherein the average calculation is a four-pole average.

15. The motor controller of claim 12, wherein the Hall signal generates a first time interval T01, a second time interval T02, a third time interval T03, and a fourth time interval T04, the modulated Hall signal has a first phase switching time and a second phase switching time, the first phase switching time is generated by the negative-edge synchronization, and the second phase switching time is equal to (T02+T03+T04+T05)/4.

16. The motor controller of claim 12, wherein the control circuit generates the modulated Hall signal by a judging criteria.

17. The motor controller of claim 12, wherein the Hall signal generates a first time interval T01, a second time interval T02, a third time interval T03, a fourth time interval T04, and a fifth time interval T05, the modulated Hall signal has a first phase switching time, and when the fifth time interval T05 is greater than or equal to (T01+T02+T03+T04)/4, the first phase switching time is equal to (T01+T02+T03+T04)/4.

18. The motor controller of claim 12, wherein the Hall signal generates a first time interval T01, a second time interval T02, a third time interval T03, a fourth time interval T04, and a fifth time interval T05, the modulated Hall signal has a first phase switching time, and when the fifth time interval T05 is less than (T01+T02+T03+T04)/4, the first phase switching time is generated by the negative-edge synchronization or a positive-edge synchronization of the Hall signal.

19. The motor controller of claim 12, wherein the control circuit further generates a rotational speed detection signal, and the rotational speed detection signal is synchronized to the modulated Hall signal.

20. The motor controller of claim 19, wherein the rotational speed detection signal is coupled to a rotational speed signal pin.

21. The motor controller of claim 12, wherein the motor controller is applied to a cooling fan.

22. The motor controller of claim 21, wherein the cooling fan is applied to an artificial intelligence computer.

23. A motor controller configured to drive a motor, wherein the motor has a motor coil, and the motor controller comprising:
a switch circuit, configured to supply a motor current to the motor coil;
a control circuit; and
a Hall sensor, configured to generate a Hall signal to the control unit, wherein the control circuit is configured to generate a modulated Hall signal to the switch circuit, the Hall signal generates a first time interval T01, a second time interval T02, a third time interval T03, and a fourth time interval T04, the modulated Hall signal has a first phase switching time and a second phase switching time, the first phase switching time is equal to (T01+T02+T03+T04)/4, and the second phase switching time is generated by a positive-edge synchronization of the Hall signal.

24. The motor controller of claim 23, wherein the control circuit further generates a rotational speed detection signal, and the rotational speed detection signal is synchronized to the modulated Hall signal.

25. The motor controller of claim 24, wherein the rotational speed detection signal is coupled to a rotational speed signal pin.

26. The motor controller of claim 23, wherein the motor controller is applied to a cooling fan.

27. The motor controller of claim 26, wherein the cooling fan is applied to an artificial intelligence computer.

28. A motor controller configured to drive a motor, wherein the motor has a motor coil, and the motor controller comprising:
a switch circuit, configured to supply a motor current to the motor coil;
a control circuit; and
a Hall sensor, configured to generate a Hall signal to the control unit, wherein the control circuit is configured to generate a modulated Hall signal to the switch circuit, the Hall signal generates a first time interval T01, a second time interval T02, a third time interval T03, and a fourth time interval T04, the modulated Hall signal has a first phase switching time and a second phase switching time, the first phase switching time is generated by a negative-edge synchronization of the Hall signal, and the second phase switching time is equal to (T02+T03+T04+T05)/4.

29. The motor controller of claim 28, wherein the control circuit further generates a rotational speed detection signal, and the rotational speed detection signal is synchronized to the modulated Hall signal.

30. The motor controller of claim 29, wherein the rotational speed detection signal is coupled to a rotational speed signal pin.

31. The motor controller of claim 28, wherein the motor controller is applied to a cooling fan.

32. The motor controller of claim 31, wherein the cooling fan is applied to an artificial intelligence computer.

33. A motor controller configured to drive a motor, wherein the motor has a motor coil, and the motor controller comprising:
a switch circuit, configured to supply a motor current to the motor coil;
a control circuit; and
a Hall sensor, configured to generate a Hall signal to the control unit, wherein the control circuit is configured to generate a modulated Hall signal to the switch circuit, the Hall signal generates a first time interval T01, a second time interval T02, a third time interval T03, a fourth time interval T04, and a fifth time interval T05, the modulated Hall signal has a first phase switching time, and when the fifth time interval T05 is greater than or equal to (T01+T02+T03+T04)/4, the first phase switching time is equal to (T01+T02+T03+T04)/4.

34. The motor controller of claim 33, wherein when the fifth time interval T05 is less than (T01+T02+T03+T04)/4, the first phase switching time is generated by a positive-edge synchronization of the Hall signal or a negative-edge synchronization of the Hall signal.

35. The motor controller of claim 33, wherein the control circuit further generates a rotational speed detection signal, and the rotational speed detection signal is synchronized to the modulated Hall signal.

36. The motor controller of claim 35, wherein the rotational speed detection signal is coupled to a rotational speed signal pin.

37. The motor controller of claim 33, wherein the motor controller is applied to a cooling fan.

38. The motor controller of claim 37, wherein the cooling fan is applied to an artificial intelligence computer.
